(19) United States
(12) Patent Application Publication
(10) Pub. No.: US 2019/0050919 A1
(43) Pub. Date: Feb. 14, 2019

(54) FOOD ORDERING SYSTEM AND METHOD BASED ON PREDEFINED VARIABLES

(71) Applicant: Rama Joshua Shadrokh, Great Neck, NY (US)

(72) Inventor: Rama Joshua Shadrokh, Great Neck, NY (US)

(21) Appl. No.: 15/672,340

(22) Filed: Aug. 9, 2017

(51) Int. Cl. G06Q 30/06; G06Q 10/08; G06Q 50/12

(52) U.S. Cl. CPC G06Q 30/0603; G06Q 30/00; G06Q 50/12; G06Q 10/087

(57) ABSTRACT

The present invention relates to a system and method of ordering food online based on a set of predefined variables. The variables used for primarily suggesting the food items are nutrients, tastes and ingredients of the previously ordered dishes or food items in the order history.

### BACKGROUND OF INVENTION

### Field of Invention

This invention relates to a system and method for ordering food online based on a set of predefined variables.

### Description of Prior Art

Any discussion of documents, acts, materials, devices, articles or the like which has been included in this specification is solely for the purpose of providing a context for the present invention. It is not to be taken as an admission that any or all of these matters form a part of the prior art base or were common general knowledge in the field relevant to the present invention as it existed in the United States of America or elsewhere before the priority date of this application.

Ordering food online is a current trend globally. While there are several food businesses focussing on catering the buyers with attractive applications profiling their data based on usual parameters including but not limited to age, location, gender, order history, geography, etc but none of these applications have gone far into the micro level analysis wherein the dishes are suggested based on extremely specific parameters that have not been employed by other online food ordering businesses till now. Some of the existing arts include U.S. Pat. No. 8,888,492B2 to Riscalla which discusses the system and methods for ordering prepared food products via a network using electronic device. While the system and method described by Riscalla enhances visual experience of the end user similar to ordering in person but does not pay attention to the micro parameters that auto suggest user specific dishes in the said system.

Another U.S. Pat. No. 9,165,320B1 to Belvin talks about system and method to enable the selection of one or more recipes by the user. The items of purchase are purchased from the electronic marketplace and can be selected based on the recipe selection. While the patent gets to the point where it targets the specific parameter i.e. ingredient but can only suggest the ingredients based on the specific recipe selected but not actually auto suggesting the dishes from the user's order history based on specific ingredients of the past ordered dishes; which is one of the attributes of the present invention.

Besides the abovementioned deficiencies, the conventional online food ordering system and methods comprise suggesting dishes based on the conventional parameters like order history of the user, nearby location coordinates, age, gender, geography etc. whereas the present invention gets to the micro level segregation of the data pertaining to order history which includes three prime parameters comprising taste, nutrition value and ingredients of the previously ordered dishes or food items and suggesting the users with the same. The conventional systems and methods associated with online food ordering do not segment the order history data to such an extent as that of the present invention. The present invention utilizes system specific algorithms to generate specific food items or dishes suggestions primarily based on the micro level segregation of the data pertaining to the order history of the user which further includes three prime parameters comprising taste, nutrition value and ingredients of the previously ordered dishes or food items. Therefore, offering a substantial improvement over the existing arts or patents in this field.

### SUMMARY OF THE INVENTION

It is an object of the present invention to overcome, or substantially ameliorate, one or more of the disadvantages of the prior art, or to provide a useful alternative.

According to an aspect of the present invention, the system utilizes system specific algorithms to generate specific food items or dishes recommendations primarily based on the micro level segregation of the data pertaining to the order history.

According to yet another aspect of present invention, the system generated recommendations of food items or dishes are further micro segmented into three prime parameters comprising taste, nutrition value and ingredients of the previously ordered dishes or food items besides conventional parameters including but not limited to age, gender, location, physiological states etc.

According to yet another aspect of present invention, the system also incorporates catering service menu for the food items and dishes of choice. The user may opt in for online food ordering or online catering services. The system conveniently allows the user to check out the cart items from multiple vendors for the ease of ordering.

According to another aspect of present invention, the user profile is generated based on very specific coordinates unlike conventional ones. These coordinates or parameters focus on the actual nutrition, ingredient and taste of the individual dishes or food items ordered by the user in the past. The unique, system specific algorithm generates suggestions which are most relevant and most likely to be ordered by the user.

The features and advantages of the present invention will become further apparent from the following detailed description of preferred embodiments, provided by way of example only, together with the accompanying drawings.

### BRIEF DESCRIPTION OF DRAWINGS

FIG. 1 shows a network diagram demonstrating the present network architecture.

FIG. 2 shows yet another network diagram showing integral components of the present network architecture.

FIG. 3 shows yet another network diagram showing key network components in function.

FIG. 4 shows a flowchart illustrating key steps of the present invention in operation.

FIG. 5 shows an exemplary screenshot of the home page of the system displaying user specific dishes recommendations.

FIG. 6 shows yet another exemplary screenshot of the user interface suggesting dishes with a detailed profile of various attributes.

FIG. 7 shows yet another exemplary screenshot of the user interface showing the order placement page.

FIG. 8 shows an exemplary screenshot displaying the order checkout page.

### DETAILED DESCRIPTION OF PREFERRED EMBODIMENTS

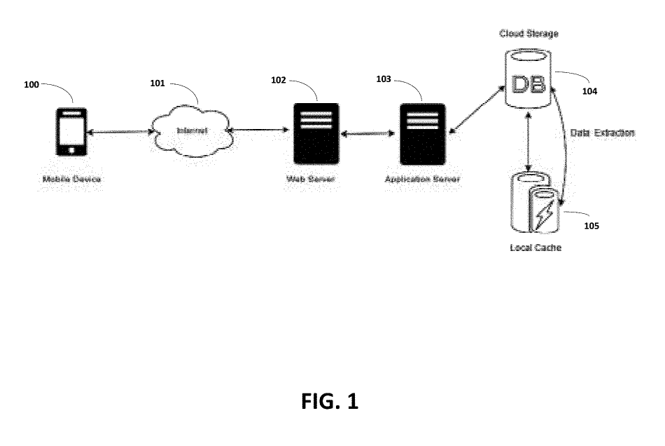

FIG. 1 shows a network diagram wherein the web server 102 serves content to the web/internet 101 which can be accessed by a mobile device 100, the application server 103 hosts business logics and withholds interaction between the user and the displayed content. The application server 103 works in conjunction with the web server 102 wherein the web server displays whereas the application server interacts. The cloud storage 104 keeps the data available and accessible to the application server 103. The local cache 105 involves caching the data on the clients rather than on the servers thus improves the overall response time of various applications and the applications themselves do not wait for sending the data across the network or to the servers. The local cache 105 and the cloud storage 104 works in conjunction for data extraction pertaining to the present invention.

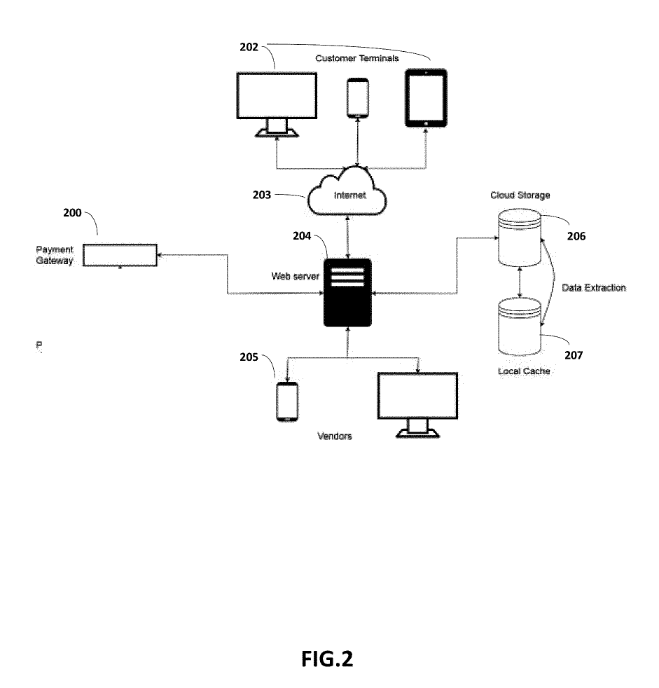

FIG. 2 shows another network diagram showing customer terminals 202 (including but not limiting to laptops, desktops, PDA's, Mobile devices, etc.) wherein the web server 204 serves the system related content to the web which can be further accessed by the customer terminals 202 via the internet. Similarly the web server serves the system related content to the vendor devices 205 (including but not limiting to laptops, desktops, PDA's, Mobile devices, etc.). The transaction data to be sent between the system and the vendor's web server is encrypted in order to be sent through the payment gateway 200.

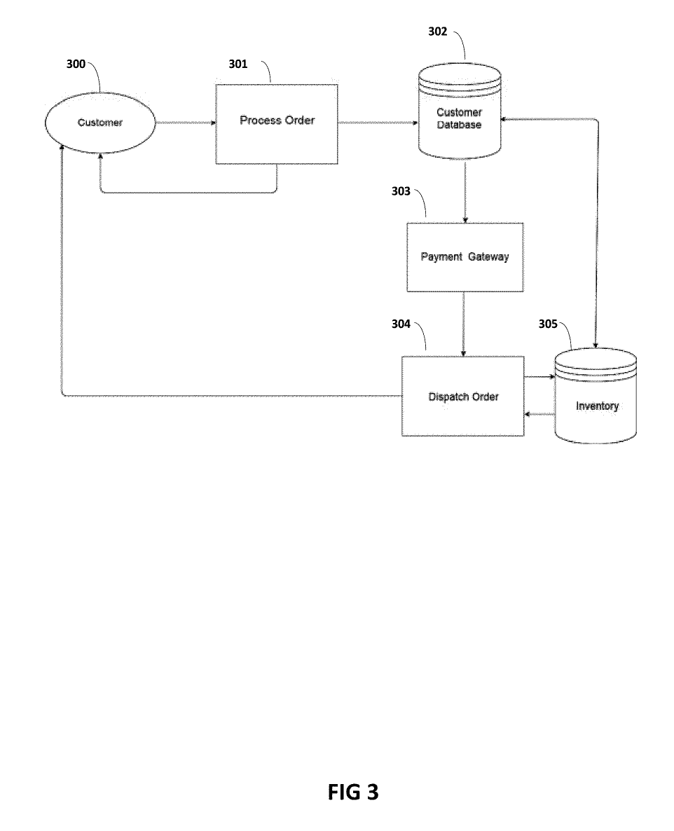

FIG. 3 illustrates a block diagram showing a system specific online food ordering workflow. The customer 300 places an order online, the specific order gets processed at 301 while the customer's order inventory 305 and other relevant details including but not limited to customer's name, address, payment method and other related data can be accessed through the customer database 302. This is followed with payment initiated by the customer via the payment gateway 303 leading to dispatch of the customer's order 304. The placed order and delivery details are further forwarded to the customer 300 thereby culminating the entire process.

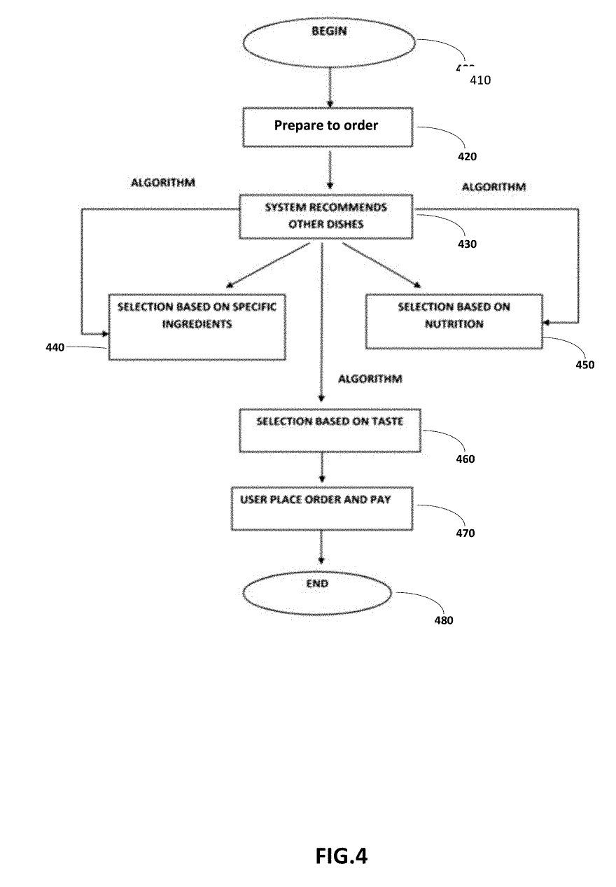

FIG. 4 shows the flowchart illustrating key steps of the present invention. The user begins the process at step 400 and prepare to order at step 420. The system simultaneously auto suggests or recommends other dishes at step 430 which are most likely to be ordered by the user. The recommendations are generated based on the unique system specific algorithm which recommends dishes based on some specific coordinates in the order history of the user account. Those specific coordinates or parameters are selected based on specific ingredients in the dishes of the past order at step 440, nutritional value of the dishes ordered in the past at step 450 and most importantly the taste associated with the dishes ordered in the past at step 460. Further on the user selects the dish or dishes of choice, places the order and pay at step 470 culminating the process at 480. The present system generated recommendations are extremely specific and customised for an individual user ordering the food unlike conventional food ordering systems wherein the prime criterion for categorising the user are typical parameters including age, gender, location, past ordered items etc. The present invention is a step ahead in generating user profile specific recommendations by going far into the micro level analysis wherein the dishes are suggested based on extremely specific parameters that have not been employed by other online food ordering platforms till now.

In the present invention, each dish will be assessed by comparing it with previously ordered dishes by the same user. The specific formula used for suggesting the dishes based on taste, ingredients and nutrients of the previously ordered dishes is:

$$\frac{Ingredients rating}{Number of ingredients in the dish} \times \frac{Macronutrient rating}{3} \times ( Taste rating ) \times 100$$

Wherein the ingredients will be valued based on coincidence in the previously ordered dishes. The value to the majority of the ingredients depend on their presence in the previously ordered Dishes, for e.g. ingredients that the user always or usually consumes (presented in more that 50% of dishes); ingredients that the user consumed more than once (but less that 50%); ingredients that the user consumed once; ingredients that the user has never consumed. The “ingredients rating” is divided between the total numbers of ingredients in the dish to normalize the final value. We have three macronutrients: carbohydrates, proteins and fats. Macronutrients also will be valued by coincidence in previously ordered dishes. The Macronutrient rating will consist of Macronutrients level in majority of the previously ordered dishes (presented in more than 50% of dishes); Macronutrients level presented more than once in previously ordered dishes (but less than 50%); Macronutrients level presented once in previously ordered dishes; Macronutrients level never presented in the dishes ordered before. The total value of the macronutrient rating is divided by 3 to normalize the final value. The taste rating consists of the taste usually presented in the previously ordered dishes (presented in more than 50% of dishes), taste presented more than once in previously ordered dishes (but less than 50%); taste presented in single consumed dish; taste never presented in the previously ordered dishes. We will get a score from 0 to 100. Dishes with a value less than half of the total (<50%) will not be shown or recommended to the users.

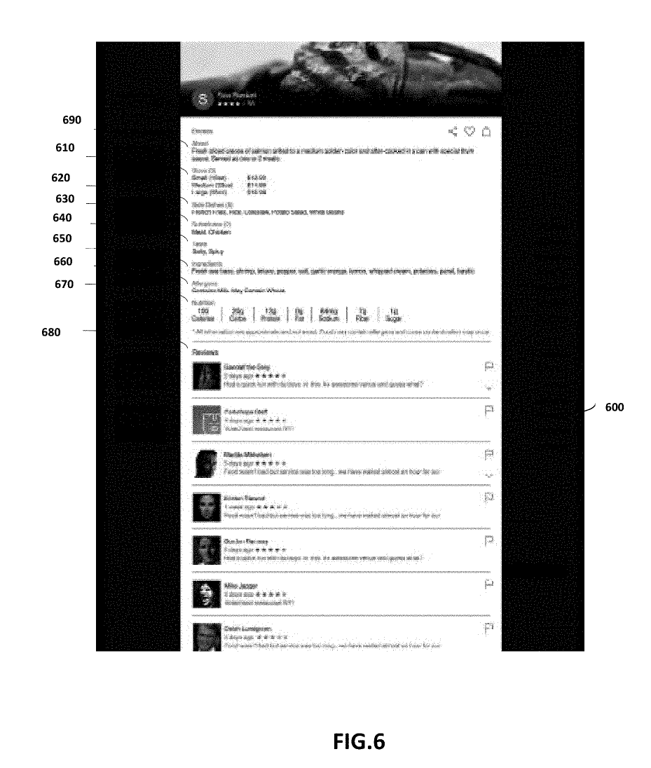

The system in the present invention also suggests dishes suiting the physiological states of the user ordering the food. For e.g. in FIG. 6, the system will auto suggest a high calcium and a high vitamin D content based dishes to a person suffering from osteoporosis or the system will auto suggest a low protein, low sugar and low alcoholic content based dishes to a person suffering from Gout. The formula employed by the system to suggest the dishes based on physiological states of the user is:

$$\frac{Ingredients rating}{{N}^{o} ingredients in the dish} \times \frac{Macronutrient rating}{3} \times ( Taste Rating ) \times \frac{Total Value Disease}{{N}^{o} parameter disease}$$

Wherein total value disease depends on the type of disease and certain parameters. Parameters will be high, medium or low and will be given a value of 1, 0.5, and 0.1 respectively according to the coincidence with the recommended parameters for the disease. For e.g. A value of 0. 1 is given if the parameter is low, 0.5 if the parameter is medium, 1 if the parameter is high. The “Total value disease” will be normalized dividing it into the total number of parameters valued for the disease. We will get a score from 0 to 100. Dishes with a value less than half of the total (<50%) will not be shown or recommended to the users.

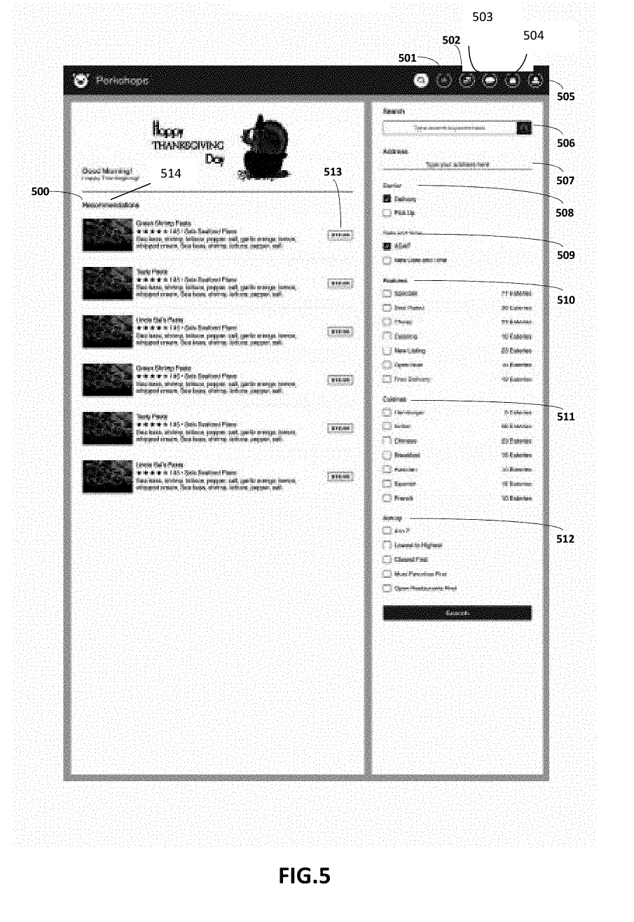

The following example will explain the working of the present invention in its entirety. Let's suppose a user ate 5 dishes on different days. These dishes were potato salad, salami Italian pasta salad, chimichurri steak, bacon cheese burger and scalloped potatoes. The system specific algorithm first finds what these dishes have in common. The system does it through ingredients “tags” of food groups and compositions (as explained in FIG. 5). The ingredient tags associated with potato salad are Potatoes, other vegetables, mayonnaise, onion, pepper, eggs, low protein, medium fat and medium starch. The ingredient tags associated with salami Italian pasta are Italian food, green legumes, olives, lunch meat, onion, other vegetables, parsley, mayonnaise, cream, yogurt, low protein, high fat and medium starch. The ingredient tags associated with chimichurri steak are Parsley, garlic, vinegar, lemon, species, spicy vegetables, meats, green leafy vegetables, potatoes, medium protein, high fat, and low starch. The ingredient tags associated with Barbeque Bacon Cheese burger are meats, other dairies, bread, green leafy vegetables, other vegetables, onion, lunch meat, medium protein, low starch and high fat. Similarly ingredient tags associated with scalloped potatoes are Potatoes, other dairies, species, strong flavour cheeses, medium protein, medium starch and medium fat.

With this information the system gauges that this person mainly likes potatoes, other vegetables, onions, dishes with a medium content of starch, and a medium content of protein. In addition, the system knows that in certain case this person would prefer dishes with mayonnaise, low protein, medium fat, lunch meat, parsley, meats, green leafy vegetables, high fat, low starch, other dairies and species. And we know if the system suggests these dishes with abovementioned tags, this person will certainly accept them. Using the last information, the system offers or suggests dishes for the next day according to the more frequently consumed ingredients by the user. For e.g. the system will now recommend the user the following dishes like Cheddar stuffed mini potatoes with ingredient tags such as potatoes, other dairies, onion, medium starch, low protein, medium fat and strong flavour cheese. The system may also recommend Vegetable salad with ingredient tags such as vegetables, potatoes, eggs, green legumes, lemon, mayonnaise, medium starch, low protein, medium fat. Similarly, the system may recommend the most appropriate dishes based on the ingredients in the order history of the user. There are certain examples of dishes that have similar tags but the system wouldn't include them as recommendations because one or more tags are out of the user preferences, for e.g. Baked potato has ingredient tags such as potato, vegetables, onion, mayonnaise, high starch, low protein and medium fat. Consequently, baked potato wouldn't be recommended by the system because it contains too much starch to the user's taste.

The system categorises the food ingredients and tastes into various groups For e.g. Table 1 shows the ingredient tags associated with various groups like green leafy vegetables, sweet vegetables, cruciferous vegetables and other vegetables and Table 2 shows the ingredient tags associated with groups like citrus fruits, tropical fruits, dry fruits and other fruits. Table 3 shows various taste groups wherein the taste of the dish will depend on the main ingredient giving the flavour. The primary taste groups are salty, sweet, sour, umami, bitter and spicy. Therefore, it is rather easier for the system to categorise and assign specific ingredient or taste tags to items following in the same group.

TABLE 1

| Food Groups | Ingredient Tags |
|---|---|
| Sweet Vegetables | Beetroot, Corn |
| Green leafy vegetables | Lettuce, Spinach, Rocket |
| Cruciferous Vegetables | Broccoli, Cauliflower, Brussels Sprouts, |
| | Cabbage |
| Other Vegetables | Zucchini, Pepper, Cucumber, Carrots, |
| | Tomatoes |

TABLE 2

| Food Groups | Ingredient Tags |
|---|---|
| Citrus Fruits | Orange, Grapes, lime, Tangerine |
| Tropical Fruits | Banana, Mango, Papaya, Pineapple |
| Dry Fruits | Dates, Raisins |
| Other Fruits | Apples, Grapes, Pear, Figs |

TABLE 3

| Taste Groups | Taste Tags |
|---|---|
| Salty | Soy sauce, salt and others |
| Sweet | BBQ sauce, Balsamic sauce, Onion sauce, |
| | teriyaki sauce and sugar. |
| Sour | Sour cream, Sour sauce |
| Umami | Glutamate, Parmesan cheese, Japanese Food |
| Bitter | Dark chocolate, Ginger and others |
| Spicy | Chilli, curry, Jalapeno |

In the present invention, system actually proposes dishes according to a percentage of assertiveness. For example, in the dish Cheddar stuffed mini potatoes, the system matched 3 ingredient tags from the user order history i.e. potatoes, onion and medium starch out of a sum total of 7 tags. Consequently the percentage of assertiveness for this dish would be 42.8% and similarly the others can be calculated. The dish with highest percentage of assertiveness will be suggested first to the user followed by the other dishes. In that case, Cheddar stuffed mini potatoes will top the suggestions list.

Apart from ingredients, the present invention also gives recommendations according to the physiological states of the users. For Individuals or users with high cholesterol, the system will never recommend dishes with fat content higher than 30% of the total calories Also the system will suggest dishes with higher monounsaturated fats and fiber. Similarly one such nutritional recommendation for individuals with high cholesterol is a Lentil Soup with high monounsaturated fats, high fiber and low overall fats. The nutrition tags for Lentil soup will be low protein, low starch and low fats besides ingredient tags like legume, oregano, vegetables and pepper. In this way, the system ultimately recommends dishes according to the user likes and needs.

FIG. 5 shows a screenshot 500 of the catalogue at the home page of the system displaying dishes recommendations 514 with prices 513. The user can select the mode of delivery 508, address 507, date and time 509, types of cuisines 511 and features 510. One can see the user profile 505 with details like rewards 502, alerts 504, chat 503 and reviews 501. The user may search specific keywords at 506. The user may sort the restaurants based on factors like most favourite restaurants, closest, opened restaurants etc. at 512.

FIG. 6 shows exemplary screenshot 600 displaying full profile of a dish to be ordered. The detailed profile consist of “about” section 690 displaying the info about the dish followed with available sizes of the dish 610, side dishes 620 to be ordered alongside, substitutes 630, taste 640, ingredients 650, allergens 660, nutrition 670 and user reviews 680. The suggestions of various dishes are made based on a unique system specific algorithm which suggest dishes based on three specific order history coordinates including taste, ingredient and nutrition value of the foods ordered by the user in the past. For example, the user ordered spicy tomato cheese pizza with coke in the order history, the system specific algorithm will suggest dishes based on high carbohydrate content, with tomatoes, dairy products and side drinks with caffeine and dishes with spicy taste quotient. All this information is gathered and processed by the system specific algorithm which fragments the order history data into ingredients, taste and nutrition parameters and suggests the user accordingly.

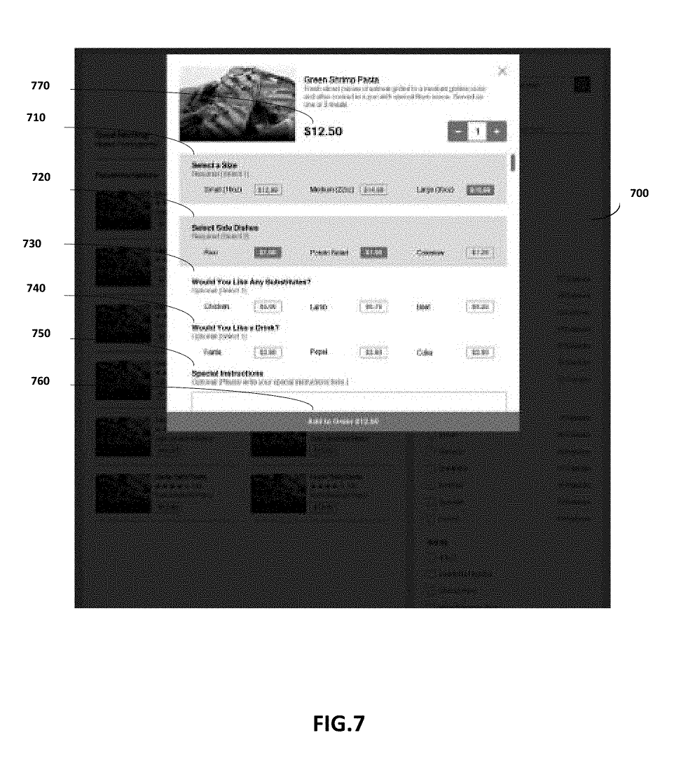

FIG. 7 shows exemplary screenshot 700 of the order placing page displaying menu options like selecting the size of the dish 710, selecting side dishes 720 or substitutes 730, drink option 740, and special instructions 750 and order total 760, price of the dish 770 respectively.

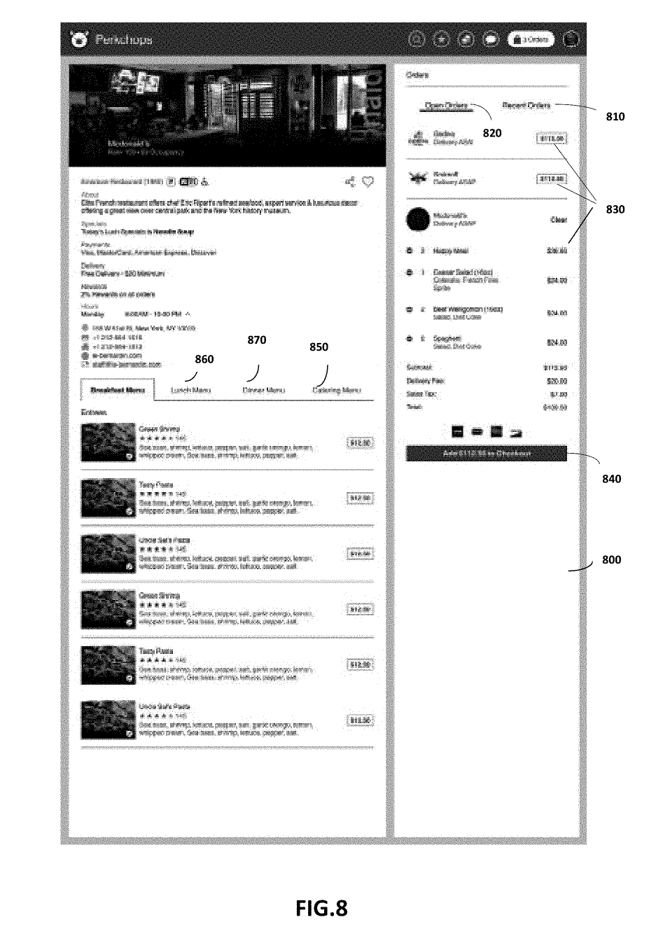

FIG. 8 shows another exemplary screenshot 800 of the order checkout page 840 displaying recent orders 810, open orders 820 and respective order amounts 830. The user may also select catering menu option 850 to select the catering orders. In case of catering, menus are usually composed by a main dish, a side dish, a dessert and a drink. The system may impart choices between options for the side dish, dessert and drinks. Every restaurant will give a minimum number of people to order or a minimum price. Suggestions will be based on the formula below:

$$( \frac{Food group rating}{Food group number} ) \times ( \frac{Macronutrient rating}{3} ) \times ( Taste rating ) \times ( Price rating ) \times 100$$

wherein food groups refer to companies or groups ordering the catering menu and food group number actually stands for the number of such groups placing the catering order.

While a number of preferred embodiments have been described, it will be appreciated by persons skilled in the art that numerous variations and/or modifications may be made to the invention without departing from the spirit or scope of the invention as broadly described. The words “dishes” or “food items” and “user” or “customer” have been used in the specification interchangeably. The present embodiments are, therefore, to be considered in all respects as illustrative and not restrictive.

What is claimed is:

1. A system and method for ordering food online wherein:
a. the system specific algorithms generates food items or dishes suggestions primarily based on the micro level segregation of the data pertaining to the order history;
b. the system generated recommendations are extremely specific and customised for an individual user ordering the food;
c. the system specific algorithm fragments the order history data into ingredients, taste and nutrition parameters and offer suggestions accordingly.

2. A system and method for ordering food online wherein the system specific algorithm fragments the order history data into three key parameters including taste, nutrition and ingredients of the previously ordered dishes and auto suggests the user food items based on these key parameters.

3. A system and method for ordering food online as claimed in claim 2, wherein the unique system specific algorithm suggests the most relevant food items likely to be ordered by the user.

4. A system and method for ordering food online as claimed in claim 3, wherein the food items suggestions are generated based on fragmenting the order history data on three key parameters including taste, nutrition and ingredients of the previously ordered dishes.

5. A system and method according to claim 1, wherein the system gives recommendations according to the physiological states of the users.

6. A system and method according to claim 5, wherein the system assign tags for various food groups, taste groups and ingredients compositions.

7. A system and method of ordering food online, wherein the system actually proposes dishes according to a percentage of assertiveness. The dish with highest percentage of assertiveness will be suggested first to the user followed by the other dishes.

8. A system and method according to claim 7, wherein the percentage of assertiveness is calculated by the number of relevant tags matched with the user's order history divided by the total number of tags in an ordered dish.

9. A system and method according to claim 8, wherein the tags can be ingredient tags, taste tags and nutrition tags.

10. A system and method for ordering food online as claimed in claim 1, wherein the user can either select the regular food menu or the catering menu depending upon the preference.

11. A system and method according to claim 1, wherein the online catalogue at the home page includes various options including but not limited to type of carrier, type of cuisine, date and time options, favourite restaurants, opened restaurants and keywords.

12. A system and method according to claim 1, wherein the detailed profile of the food items to be ordered comprise of information like ingredients used, allergens, recommended side dishes, available sizes, nutrition profile, user reviews, taste and substitutes.

13. A system and method according to claim 12, wherein the said system conveniently allows the user to check out the cart items from multiple vendors for the ease of ordering.

14. A system and method according to claim 1, wherein the customer's order inventory and other relevant details including but not limited to customer's name, address, payment method and other related data can be accessed through the customer database.

15. A system and method according to claim 14, wherein the payment initiated by the customer via the payment gateway leads to the dispatch of the customer's order. The placed order and delivery details are further forwarded to the customer thereby culminating the entire process.
